(19) United States
(12) Patent Application Publication
(10) Pub. No.: US 2025/0088414 A1
(43) Pub. Date: Mar. 13, 2025

(54) METHOD FOR OPERATING A SERVICE PROVISION NETWORK, CONTROL DEVICE FOR CARRYING OUT SUCH A METHOD AND SERVICE PROVISION NETWORK HAVING SUCH A CONTROL DEVICE

(71) Applicant: Rolls-Royce Solutions GmbH, Friedrichshafen (DE)

(72) Inventors: Carsten Schäfer, Ravensburg (DE); Alexander Bernhard, Meckenbeuren (DE); Dennis Beermann, Konstanz (DE)

(73) Assignee: Rolls-Royce Solutions GmbH, Friedrichshafen (DE)

(21) Appl. No.: 18/960,875

(22) Filed: Nov. 26, 2024

Related U.S. Application Data
(63) Continuation of application No. PCT/EP2023/064042, filed on May 25, 2023.

(30) Foreign Application Priority Data
May 30, 2022 (DE) 10 2022 113 617.5

(51) Int. Cl. H04L 41/0806; H04L 41/0823; H04L 41/0895; H04L 47/125

(52) U.S. Cl. CPC H04L 41/0806; H04L 41/0823; H04L 41/0895; H04L 47/125

(57) ABSTRACT

A method of operating a service provision network, the method including the steps of: providing that the service provision network includes at least two service provision devices; splitting a load demand on the service provision network between the at least two service provision devices and a virtual service provision device to optimize a cost function, a load distribution being obtained; and operating the at least two service provision devices according to the load distribution obtained.

### CROSS REFERENCE TO RELATED APPLICATIONS

This is a continuation of PCT application no. PCT/EP2023/064042, entitled “METHOD FOR OPERATING A SERVICE PROVISION NETWORK, CONTROL DEVICE FOR CARRYING OUT SUCH A METHOD AND SERVICE PROVISION NETWORK HAVING SUCH A CONTROL DEVICE”, filed May 25, 2023, which is incorporated herein by reference. PCT application no. PCT/EP2023/064042 claims priority to German patent application no. 10 2022 113 617.5, filed May 30, 2022, which is incorporated herein by reference.

### BACKGROUND OF THE INVENTION

### 1. Field of the Invention

The present invention relates to service provision networks.

### 2. Description of the Related Art

Service provision devices typically physically track the load demands placed on them.

In order to achieve, in particular, computer-aided load distribution, it would be desirable to be able to mathematically distribute a load demand on the service provision network, which has at least two service provision devices, to the at least two service provision devices in such a manner that a cost function is optimized.

However, an optimization problem resulting from the cost function is mathematically only permissible if the sum of the available powers of at least two service provision devices is at least as large as the load demand. However, situations are conceivable in which the sum of the available powers of at least two service provision devices is less than the load demand. For example, such a situation arises if the load demand increases by a certain amount, for example 500 kW, within a few seconds and the power of at least two service provision devices can only be increased at a lower rate, for example by 200 kW per minute, for physical or technical reasons. This means that the optimization problem with the load demand constraint is not permissible and therefore no load distribution can be calculated.

What is needed in the art is a method for operating a service provision network, a control device for carrying out such a method and a service provision network with such a control device, wherein the aforementioned disadvantages are at least partially eliminated, optionally avoided.

### SUMMARY OF THE INVENTION

The invention relates to a method for operating a service provision network, a control device for carrying out such a method and a service provision network with such a control device.

The present invention provides a method for operating a service provision network which has at least two-in particular physical-service provision devices. A load demand on the service provision network is split between the at least two service provision devices and a virtual service provision device by optimizing a cost function, wherein a load distribution is obtained. The at least two service provision devices are then operated according to the load distribution obtained.

The load distribution received assigns a power to each service provision device and a virtual power to the virtual service provision device. Advantageously, a sum of the powers assigned to the at least two service provision devices and the virtual power of the virtual service provision device can thus always be exactly as large as the load demand. This means that the cost function can be optimized at any time. The method thus advantageously allows, in particular, computer-aided and thus simple, exact, computerized and, in particular, automatic load distribution.

The virtual power is not a real or physical power, but a pure calculation variable for solving the optimization problem. In particular, the virtual power assumes a positive value if at a point in time the sum of the powers assigned to the at least two service provision devices is less than the load demand. Alternatively, the virtual power assumes a negative value if the sum of the powers assigned to at least two service provision devices is greater than the load demand at a point in time. Physically, the service provision network reacts to the at least two service provision devices falling below the load demand by an electrical frequency of an alternating voltage in the service provision network initially collapsing, rising again with an increase in the power assigned to the at least two service provision devices and then reaching a target frequency again when the sum of the powers assigned to the at least two service provision devices is as high as the load demand. Physically, the service provision network reacts to an exceeding of the load demand by the at least two service provision devices—in particular in the event of a sudden drop in load, wherein the at least two service provision devices cannot be regulated down quickly enough due to their inertia—in that an electrical frequency of an alternating voltage in the service provision network initially rises, falls again with a decrease in the power assigned to the at least two service provision devices and then reaches the setpoint frequency again when the sum of the powers assigned to the at least two service provision devices has fallen to the decreased load demand.

In the context of the present technical teaching, a distinction is made between a—in particular physical—service provision device and a virtual service provision device. In particular, a physical service provision device is a real existing device that can provide physically usable power. In contrast, a virtual service provision device is a computational concept that cannot provide physical usable power.

In one embodiment, the optimization problem for two service provision devices and one virtual service provision device is

$$min K ( {P}_{1} , {P}_{2} , {P}_{v} ) = {P}_{1} {k}_{1} + {P}_{2} {k}_{2} + \vert {P}_{v} {k}_{v} \vert$$

under the secondary conditions

$${P}_{1} + {P}_{2} + {P}_{v} = {P}_{Last}$$

$${P}_{1 , min} \leq {P}_{1} \leq {P}_{1 , max}$$

$${P}_{2 , min} \leq {P}_{2} \leq {P}_{2 , max}$$

$$0 \leq {P}_{v}$$

with the cost function K, the assigned powers P₁ and P₂ of the two service provision devices, the virtual power Pᵥ of the virtual service provision device and the predetermined costs or energy prices kᵢ assigned to the individual service provision devices, the load demand P_{Last}. P_{1,max} and P_{2,max} being upper power limits assigned to the service provision devices or, in other words, the maximum power currently available. In particular, at least one of these upper power limits is time-dependent, in particular dependent on at least one instantaneous physical variable of the associated service provision device, for example an instantaneous charge pressure. In particular, the at least one time-dependent power upper limit P_{i,max}(t) has a limited rate of change \dot{P}_{i,max}. This means that the available power of at least one service provision device cannot be increased as quickly as desired, which in turn results in particular in the problem described at the beginning that the sum of the powers P₁, P₂ assigned to the service provision devices can be less than the load demand P_{Last} at certain times. P_{1,min} and P_{2,min} are lower power limits assigned to the service provision devices. These can be time-dependent, but also constant over time. In particular, it is possible that at least one of the power lower limits P_{1,min}, P_{2,min} is zero. In particular, it is possible that both power lower limits P_{1,min}, P_{2,min} are equal to zero.

In particular, the method is carried out iteratively. In particular, the at least one time-dependent upper power limit changes over time, so that the load distribution also changes accordingly, in particular until the assigned powers P₁, P₂ are equal in total to the load demand P_{Last}. In particular, due to the decreasing amount of virtual power Pᵥ over the iteration cycles due to the specific high cost, the service provision network iteratively assumes a state in which the allocated powers P₁, P₂ are equal in sum to the load demand P_{Last}. It is possible that the method will not be carried out again until either the load demand P_{Last} or the energy costs kᵢ change. However, it is also possible for the method to be carried out iteratively on an ongoing basis.

According to a further development of the present invention, it is provided that the cost function is optimized taking into account at least one additional constraint.

In one embodiment, by way of the at least one additional constraint, in particular a maximum possible power change of the instantaneous power per time unit of at least one service provision device of the at least two service provision devices, is taken into account.

In particular, the at least one assigned power Pᵢ has a limited rate of change \dot{P}ᵢ. This means that the power of at least one service provision device cannot be increased as quickly as desired, which in turn results in particular in the problem described at the beginning that the sum of the powers P₁, P₂ assigned to the service provision devices can be less than the load demand P_{Last} at certain times.

In an optional embodiment, a first additional constraint of the form

$${a}_{1 , min} \leq {\dot{P}}_{1} \leq {a}_{1 , max}$$

arises, with the minimum power change rate α_{1,min} and maximum power change rate α_{1,max} assigned to the rate of change \dot{P}₁. Alternatively or additionally, there is a second additional constraint of the form

$${a}_{2 , min} \leq {\dot{P}}_{2} \leq {a}_{2 , max}$$

with the minimum power change rate α_{2,min} and maximum power change rate α_{2,max} assigned to the rate of change \dot{P}₂.

If the maximum possible power change per time unit is taken into account via a secondary condition, the above-mentioned upper power limits P_{1,max} and P_{2,max} can also be static limits, which correspond in particular to the respective rated power of the service provision device.

According to a further embodiment of the present invention, it is provided that the cost function is calculated using the energy prices of the at least two service provision devices and predetermined costs of the virtual service provision device. In addition, the predetermined cost of the virtual service provision device is selected to be greater than each of the energy prices of the at least two service provision devices.

Advantageously, this ensures that the virtual service provision device is only called in if the sum of the powers assigned to the at least two service provision devices is less than the load demand.

In particular, the predetermined costs of the virtual service provision device are chosen to be at least 1 cent per kWh more expensive than the energy prices of the at least two, in particular, physical service provision devices.

In one embodiment, the cost function K is optionally additionally calculated using the maintenance costs for the at least two service provision devices and virtual maintenance costs of the virtual service provision device. In addition, the virtual maintenance costs of the virtual service provision device are chosen to be more expensive than the maintenance costs of at least two service provision devices. This can advantageously be used to control that at least two service provision devices are operated in a low-wear operating mode.

In particular, the predetermined costs for the virtual power are chosen to be at least 10%, in particular at least 20%, in particular at least 30%, in particular at least 40%, in particular at least 50%, in particular at least 75%, in particular at least 100%, in particular 150%, in particular at least 200%, greater than the energy prices of the at least two, in particular physical, service provision devices in order to ensure stable and rapid optimization of the cost function K. In particular, the predetermined costs kᵥ for the virtual power are determined on the basis of the energy prices of the at least two, in particular physical, service provision devices using the equation

$${k}_{v} = f {max}_{i} ( {k}_{i} )$$

wherein a factor f is predetermined and is greater than 1, in particular greater than 1.1, in particular greater than 1.2, in particular greater than 1.3, in particular greater than 1.4, in particular greater than 1.5, in particular greater than 1.75, in particular greater than 2, in particular greater than 2.5, in particular greater than 3. Alternatively or additionally, the virtual maintenance costs are selected to be at least 10%, in particular at least 20%, in particular at least 30%, in particular at least 40%, in particular at least 50%, in particular at least 75%, in particular at least 100%, in particular 150%, in particular at least 200%, greater than the maintenance costs for the at least two service provision devices.

According to a further embodiment of the present invention, it is provided that the load distribution is determined by minimizing the cost function.

Advantageously, this makes it possible to operate the service provision network as cost-effectively as possible, taking into account the specific costs of the service provision devices.

According to a further embodiment of the present invention, it is provided that an electric machine operatively connected to an internal combustion engine is used as at least one service provision device of the at least two service provision devices.

According to a further embodiment of the present invention, it is provided that an energy storage device is used as at least one service provision device of the at least two, in particular physical, service provision devices.

In an optional embodiment, a heat storage device is used as the energy storage device.

In a further optional embodiment, a mechanical device selected from a group consisting of a flywheel accumulator, a spring, a pump accumulator, a compressed air accumulator and a lift accumulator is used as the energy storage device.

In another optional embodiment, an electrical device selected from a group consisting of a battery, an accumulator and a capacitor is used as the energy storage device.

In a further optional embodiment, the electric machine drivingly operatively connected to the internal combustion engine is used as at least one service provision device of the at least two service provision devices, wherein in particular the electric machine drivingly operatively connected to an internal combustion engine is referred to as a genset. Alternatively or additionally, the energy storage device is used as at least one of the at least two service provision devices.

In one embodiment, the service provision network has at least one additional service provision device. In particular, a photovoltaic system is used as the at least one additional service provision device. Alternatively or additionally, a wind power system is used as the at least one additional service provision device. Alternatively or additionally, the at least one additional service provision device is a hydropower system.

According to a further embodiment of the present invention, a load prediction is provided for a predetermined prediction horizon. The load distribution is then determined for a number of points in time within the predetermined prediction horizon.

The present invention also provides a control device, wherein the control device is set up to carry out a method according to the present invention or a method according to any one or more of the embodiments described above. The control device is optionally designed as a computing device, particularly optionally as a computer, or as a control device, particularly as a control device of a service provision network. In connection with the control device, the advantages already explained in connection with the method arise in particular.

The control device is optionally set up to be operatively connected to the at least two service provision devices and set up to control them respectively.

In particular, the virtual service provision device is a computing concept stored or implemented in the control device.

Finally, the present invention also provides a service provision network having at least two service provision devices and a control device according to the present invention or a control device according to one or more of the embodiments described above. In connection with the service provision network, the advantages already explained in connection with the method and the control device arise in particular.

The control device is operatively connected to the at least two service provision devices and is set up to control each of them.

According to a further embodiment of the present invention, it is provided that at least one service provision device of the at least two service provision devices is designed as an electric machine operatively connected to an internal combustion engine. Alternatively or additionally, at least one service provision device of the at least two service provision devices is designed as an energy storage device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic representation of an embodiment of a service provision network; and

FIG. 2 shows a flowchart of an embodiment of a method for operating the service provision network.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

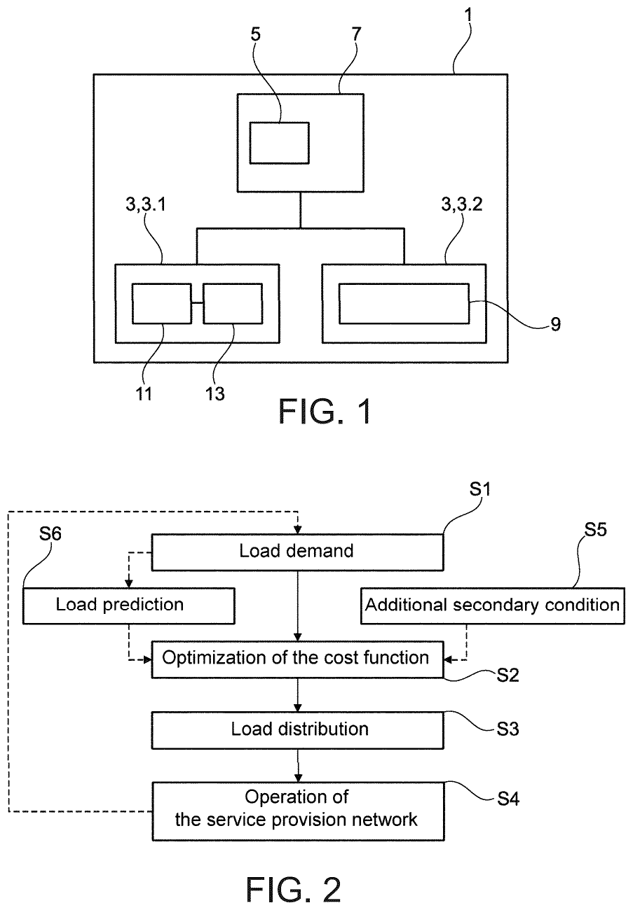

FIG. 1 shows a schematic representation of an embodiment example of a service provision network 1.

The service provision network 1 has at least two, in particular physical, service provision devices 3, in particular a first service provision device 3.1 and a second service provision device 3.2, a control device 7 and a schematically depicted virtual service provision device 5 implemented as a mathematical calculation concept in the control device 7.

Optionally, at least one service provision device 3 of the at least two service provision devices 3 is an energy storage device 9. Alternatively or additionally, optionally at least one service provision device 3 of the at least two service provision devices 3 is an electric machine 13 drivingly operatively connected to an internal combustion engine 11.

In one embodiment, the service provision network 1 has at least one additional service provision device 3. In one embodiment example, the at least one additional service provision device 3 is a photovoltaic system. Alternatively or additionally, the at least one additional service provision device 3 is a wind power system. Alternatively or additionally, the at least one additional service provision device 3 is a hydropower system.

The control device 7 is operatively connected to the at least two service provision devices 3 and is set up to control each of them. Furthermore, the control device 7 is set up to carry out a method for operating the service provision network 1 and to determine a load distribution for the at least two, in particular physical, service provision devices 3. The method is explained in more detail below with reference to FIG. 2.

FIG. 2 shows a flowchart of an embodiment of a method for operating the service provision network 1.

In a first step S1, a load demand is specified for the service provision network 1.

In a second step S2, the predetermined load demand is divided between the at least two service provision devices 3 and a virtual service provision device 5 by optimizing a cost function. Optionally, the cost function is calculated using the energy prices of the at least two service provision devices 3 and an energy price of the virtual service provision device 5. Optionally, the energy price of the virtual service provision device 5 is assumed to be greater than the energy prices of the at least two service provision devices 3. Alternatively or additionally, the cost function is optionally minimized.

In a third step S3, a load distribution is obtained.

Subsequently, in a fourth step S4, the at least two service provision devices 3 are operated according to the load distribution obtained.

In an optional fifth step S5, at least one additional constraint is established, wherein the cost function in the second step S2 is optimized taking into account the at least one additional constraint.

In an optional sixth step S6, a load prediction for a predetermined prediction horizon is specified, in particular based on the load demand. Then, in the second step S2 and the third step S3, the load distribution is determined for each point in time within the predetermined prediction horizon.

Optionally, steps S1 to S4, in particular including the fifth step S5 and/or the sixth step S6, are performed iteratively or cyclically, in particular with a predetermined time interval, in order to determine a load distribution and to operate the service provision network in accordance with the load distribution.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating a service provision network, the method comprising the steps of:
providing that the service provision network includes at least two service provision devices;
splitting a load demand on the service provision network between the at least two service provision devices and a virtual service provision device to optimize a cost function, a load distribution being obtained; and
operating the at least two service provision devices according to the load distribution obtained.

2. The method according to claim 1, wherein the cost function is optimized taking into account at least one additional constraint.

3. The method according to claim 1, wherein the cost function is calculated based on a plurality of energy prices of the at least two service provision devices and based on a plurality of predetermined costs of the virtual service provision device, wherein the plurality of predetermined costs of the virtual service provision device are assumed to be greater than each of the plurality of energy prices of the at least two service provision devices.

4. The method according to claim 1, wherein the load distribution is determined by minimizing the cost function.

5. The method according to claim 1, wherein an electric machine drivingly operatively connected to an internal combustion engine is used as at least one of the at least two service provision devices.

6. The method according to claim 1, wherein an energy storage device is used as at least one of the at least two service provision devices.

7. The method according to claim 1, wherein a load prediction is predetermined for a predetermined prediction horizon, wherein the load distribution is determined for each time point within the predetermined prediction horizon.

8. A control device, comprising:
the control device, which is structured and arranged to carry out a method of operating a service provision network which includes at least two service provision devices, the method including the steps of:
splitting a load demand on the service provision network between the at least two service provision devices and a virtual service provision device to optimize a cost function, a load distribution being obtained; and
operating the at least two service provision devices according to the load distribution obtained.

9. A service provision network, comprising:
a control device; and
at least two service provision devices which are operatively connected to the control device, wherein the control device is structured and arranged to carry out a method of operating the service provision network which includes the at least two service provision devices, the method including the steps of:
splitting a load demand on the service provision network between the at least two service provision devices and a virtual service provision device to optimize a cost function, a load distribution being obtained; and
operating the at least two service provision devices according to the load distribution obtained.

10. The service provision network according to claim 9, wherein at least one of:
(a) at least one of the at least two service provision devices is as an electric machine drivingly connected to an internal combustion engine; and
(b) at least one of the at least two service provision devices is an energy storage device.
